(19) United States
(12) Patent Application Publication
(10) Pub. No.: US 2013/0282871 A1
(43) Pub. Date: Oct. 24, 2013

(54) STREAMING SERVICE TRANSMITTING/RECEIVING DEVICE AND METHOD

(71) Applicants: Soon Heung Jung, Daejeon (KR); Kwang Deok Seo, Seoul (KR); Jin Young Lee, Daejeon (KR); Seong Jun Bae, Daejeon (KR); Jung Won Kang, Daejeon (KR); Sang Woo Shim, Seoul (KR); Truong Cong Thang, Daejeon (KR); Sang Taick Park, Daejeon (KR); Won Ryu, Daejeon (KR)

(72) Inventors: Soon Heung Jung, Daejeon (KR); Kwang Deok Seo, Seoul (KR); Jin Young Lee, Daejeon (KR); Seong Jun Bae, Daejeon (KR); Jung Won Kang, Daejeon (KR); Sang Woo Shim, Seoul (KR); Truong Cong Thang, Daejeon (KR); Sang Taick Park, Daejeon (KR); Won Ryu, Daejeon (KR)

(73) Assignees: Industry-Academy Cooperation Foundation,Yonsei University, Seodaemun-gu (KR); Electronics and Telecommunictions Research Instutute, Daejeon (KR)

(21) Appl. No.: 13/880,941

(22) PCT Filed: Oct. 20, 2011
(86) PCT No.: PCT/KR2011/007827

§ 371 Date: Jul. 3, 2013

(30) Foreign Application Priority Data
Oct. 20, 2010 (KR) 10-2010-0102574
Apr. 4, 2011 (KR) 10-2011-0030790

(51) Int. Cl. H04L 29/06

(52) U.S. Cl. CPC H04L 65/60
USPC 709/219

(57) ABSTRACT

Provided is an apparatus and method for transmitting and receiving a streaming service. An inter-arrival jitter may correspond to a delay variation in arrival time between TCP packets arriving at an apparatus for receiving the streaming service. The apparatus for receiving the streaming service may determine a de-jitter buffering time to absorb a network jitter before TS packets in a TCP packet is input to a T-STD buffer model. Based on the de-jitter buffering time, an initial playout delay lime at the apparatus for receiving the streaming service may be determined.

### TECHNICAL FIELD

The present invention relates to a system for transmitting/receiving a streaming service, and more particularly, to an apparatus and method for transmitting/receiving a progressive streaming service using a de-jitter buffering time estimation.

### BACKGROUND ART

A scheme for performing a video on demand (VoD) service through an Internet protocol (IP) network such as the Internet may include a streaming scheme and a downloading scheme.

A streaming scheme service may perform real-time transport protocol (RTP) packetization of a multimedia payload, and then load an RTP packet on a user datagram protocol (UDP) to transmit the RTP packet.

However, even though the UDP may be suitable tor transmitting a real-time multimedia, the UDP may fail to provide a function of enhancing a quality of service (QoS) by retransmitting a packet discarded during a transmission.

A digital video format such as H.264, and the like may be compressed using a prediction based coding between frames. Thus, when a predetermined packet, among packets of the digital video, is discarded, an error due to the discarded packet may be propagated through ensuing video frames until being blocked by a subsequent I-frame that is received after the discarded packet.

That is, real-time multimedia streaming based on an RTP/UDP may be suitable for a real-time service that requires a low delay, and may be unsuitable in terms of the QoS.

When the downloading scheme is used, a client system may start a playout after downloading an entire image file. Thus, a user of the client system may enjoy a relatively high-quality service. However, the downloading scheme may have issues such as 1) and 2) described in the following.

1) A user may view an image after a relatively long period of downloading time.

2) A client side may prepare a storage space for downloading and storing an entire image file.

A progressive streaming service may be similar to a download, in that a transmission control protocol (TCP) is used as a transmission protocol. The progressive streaming service may be similar to a real-time streaming in that previously received media data is played out in real time while a file including media data is being downloaded. Accordingly, the progressive streaming service may be considered a technology that utilizes merits of both of a download and a streaming.

A moving picture experts group (MPEG) transport stream (TS) may correspond to a transmission protocol standard for multiplexing compression data of an audio and a video through a broadcasting network such as a digital video broadcasting (DVB), an integrated service digital broadcasting (ISDB), an advanced television system committee (ATSC), a digital multimedia broadcasting (DMB), and the like, and transferring the multiplexed compression data.

Based on a progressive streaming technology, a streaming service for transmitting, using a hyper text transport protocol (HTTP) and a TCP, the MPEG TS through a wired and wireless IP network may be provided.

### DISCLOSURE OF INVENTION

### Technical Goals

An aspect of the present; invention provides an apparatus and method for transmitting/receiving a streaming service that transmits a transmission control protocol (TCP) packet including information used for calculating an inter-arrival jitter.

Another aspect of the present invention provides an apparatus and method for transmitting/receiving a streaming service that calculates an inter-arrival jitter based on a point in time at which a TCP packet arrives, and a point in time at which a TCP packet is expected to arrive.

### Technical Solutions

According to an aspect of the present invention, there is provided a method of transmitting a streaming service, the method including loading at least one transport stream (TS) packet in a payload of a transmission control protocol (TCP) packet, setting, to a program clock reference (PCR) of the TCP packet, initial PCR information in the at least one TS packet in the payload, calculating a timestamp of the TCP packet based on the PCR, recording the timestamp in the TCP packet, and transmitting the TCP packet to a terminal wherein the timestamp corresponds to a point in time at which the TCP packet is expected to arrive at the terminal.

The method may further include verifying whether a TS packet, among the at least one TS packet loaded in the pay-load, having the PCR information is included in a TS header.

The timestamp may express, by a system time clock count value using a system clock frequency, an expected point in time at which a first byte of the payload is estimated to arrive at the terminal.

The timestamp may include a base clock and an extension clock, and the base clock may use a smaller frequency unit when compared to the extension clock.

A length of bits of the timestamp may be determined based on an accuracy of a delay variation in arrival time requested by the terminal.

The recording may include storing the timestamp in an options field in a header of the TCP package.

According to another a aspect of the present invention, there is provided an apparatus for transmitting a streaming service, the apparatus including a TS packet loading unit to load at least one TS packet in a payload of a TCP packet, a PCR setting unit to set, to a PCR of the TCP packet, initial PCR information in the at least one TS packet in the payload, a timestamp calculating unit to calculate a timestamp of the TCP packet based on the PCR, a timestamp recording unit to record the timestamp in the TCP packet, arid a transmitter to transmit the TCP packet to a terminal, wherein the timestamp corresponds to a point in time at which the TCP packet is expected to arrive at the terminal.

According to still another aspect of the present invention, there is provided a method of receiving a streaming service, the method including receiving a first TCP packet measuring a first clock count of a system time clock at a moment the first TCP packet is received, extracting, from the first TCP packet, a first timestamp of the first TCP packet, calculating a de-jitter buffering time based on the first clock count, the first timestamp, a second clock count, and a second timestamp, wherein the first timestamp corresponds to a point in time at which a server expects the first TCP packet to be received, the second clock count corresponds to a system time clock at a moment a second TCP packet, that is received before the TCP packet, is received, and the second timestamp corresponds to a point in time, extracted from the second TCP packet, at which the server expects the second TCP packet to be received.

The calculating may include calculating a first network jitter experienced by the first TCP packet based on the first clock count and the first time-stamp, calculating a first inter-packet spacing between the second TCP packet and the first TCP packet based on the first network jitter and a second network jitter experienced by the second TCP packet, and calculating the de-jitter buffering time based on the first network jitter and the first inter-packet spacing.

The calculating may include calculating a first inter-arrival jitter of the first TCP packet based on the first inter-packet spacing and a second inter-arrival jitter of the second TCP packet, the first inter-arrival jitter corresponding to a delay variation in arrival time between packets that arrive continuously, circulating a first inter arrival variance of the first TCP packet based on the first inter-packet spacing, s second inter-arrival variance and a second inter-packet spacing of the second TCP packet, and calculating the de-jitter buffering time based on the first inter-arrival jitter and the first inter-arrival variance.

The first timestamp may be within an options field in a header of the first TCP packet.

The method may further include determining, to be a final de-jitter buffering time, one of the de-jitter buffering time and an analyzing time, wherein the analyzing time corresponds to a period of time sufficient for receiving and analyzing TCP packets to be received.

The method may further include, setting the de-jitter buffering time to a buffering time of a transport stream system target decoder.

According to yet another aspect of the present invention, there is provided an apparatus for receiving a streaming service, the apparatus including a receiver to receive a first TCP packet, a clock count measuring unit to measure a first clock count of a system time clock at a moment the first TCP packet is received, a timestamp extracting unit to extract, from the first TCP packet, a first timestamp of the first TCP packet, and a de-jitter buffering time calculating unit to calculate a de-jitter buffering time based on the first clock count, the first time-stamp, a second clock count, and a second timestamp, wherein the first timestamp corresponds to a point in time at which a server expects the first TCP packet to be received, the second clock count corresponds to a system time clock at a moment a second TCP packet, that is received before the TCP packet, is received, and the second timestamp corresponds to a point in time, extracted from the second TCP packet, at which the server expects the second TCP packet to be received.

### EFFECT OF THE INVENTION

According to aspects of the present invention, there is provided an apparatus and method for transmitting/receiving a streaming service that transmits a transmission control protocol (TCP) packet including information used for calculating an inter-arrival jitter.

According to aspects of the present invention, there is provided an apparatus and method for transmitting/receiving a streaming service that calculates an inter-arrival jitter based on a point in time at which a TCP packet arrives, and a point in time at which a TCP packet is expected to arrive.

### BRIEF DESCRIPTION OF DRAWINGS

FIG. 1 is a diagram illustrating an overview of a progressive streaming service based on a hyper text transport protocol (HTTP) according to embodiments of the present invention.

FIG. 2 is a diagram illustrating an overview of a progressive streaming service based on a moving picture experts group (MPEG) transport stream (TS) according to embodiments of the present invention.

FIG. 3 is a diagram illustrating a configuration of an MPEG TS packet according to embodiments of the present invention.

FIG. 4 is a diagram illustrating a standard transport stream system target decoder (T-STD) buffer model according to embodiments of the present invention.

FIG. 5 is a diagram illustrating a delay variation in an arrival time of a packet in an internet protocol (IP) network according to embodiments of the present invention.

FIG. 6 is a diagram illustrating a transmission control protocol (TCP) payload format including n MPEG TS packets according to embodiments of the present invention.

FIG. 7 is a diagram illustrating a configuration of a TCP packet that includes, in a TCP payload, TS packets including program clock reference (PCR) information in a header according to embodiments of the present invention.

FIG. 8 is a diagram illustrating a timing model for predicting, at a transmission side, a point in time at which a TCP packet arrives at a reception side according to embodiments of the present invention.

FIG. 9 is a flowchart illustrating an operational method of a transmission side according to embodiments of the present invention.

FIG. 10 is a diagram illustrating a fundamental configuration of a header 310 of a TCP packet and a configuration of an extension field that may be selectively used according to embodiments of the present invention.

FIG. 11 is a diagram illustrating a configuration of a transmission side 1100 according to embodiments of the present invention.

FIG. 12 is a flowchart illustrating an operational method of a reception side according to embodiments of the present invention.

FIG. 13 is a diagram illustrating a T-STD buffer model including a de-jitter buffering according to embodiments of the present invention.

FIG. 14 is a diagram illustrating a configuration of a reception side 1400 according to embodiments of the present invention.

FIG. 15 is a diagram illustrating a delay of a media playout time by a deciliter buffering according to embodiments of the present invention.

### BEST MODE FOR CARRYING OUT THE INVENTION

Reference will now be made in detail to embodiments of the present invention, examples of which are illustrated in the accompanying drawings, wherein, like reference numerals refer to the like elements throughout. The embodiments are described below in order to explain the present invention by referring to the figures.

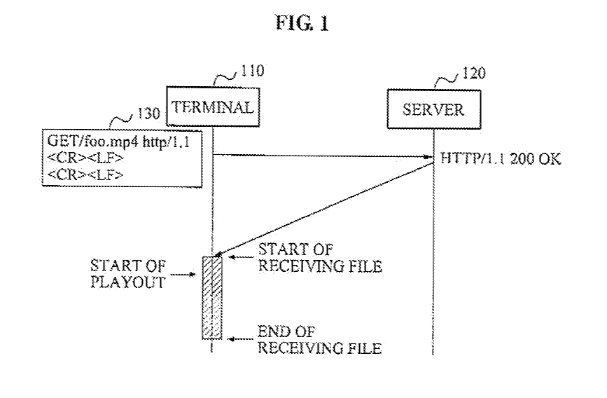

FIG. 1 is a diagram illustrating an overview of a progressive streaming service based on a hyper text transport protocol (HTTP) according to embodiments of the present invention.

A terminal (that is, a client) 110 may transmit a “GET Request” 130 of an HTTP to inform a server 120 about a service request for a desired content file.

The server 120 may transmit a content file to the terminal 150. The server 120 may use a transmission control protocol (TCP) as a transmission protocol for transmitting the content file to secure a quality of service (QoS).

The content file may arrive at the terminal 110 by the TCP.

The terminal 110 may buffer a portion of data of an initially arrived content file.

To decrease a service delay time that corresponds to an issue of a conventional download scheme, the terminal 110 may display data in a TCP packet that arrives in real time starting from an arrival of a TCP packet, filled in a buffer by a predetermined amount, at the terminal 110. That is, the terminal 110 may play out a video and an audio by parsing a portion of data of a buffered content file.

Thus, the progressive streaming service based on the HTTP may be differentiated from a download scheme in which a content file is played out after all data of the content file arrives at the terminal 110. The progressive streaming service based on the HTTP may shorten a service delay time that corresponds to an issue of a conventional download scheme, and may secure the QoS.

A content file transmitted in a conventional progressive streaming service may be generated in a file format, standard such as a QuickTime (.mov), MPEG-4 (.mp4), a Windows Media Video (.wmv), flash Video (.flv), and 3GPP (.3gp) to store a compressed video and audio in a single file.

The file format standards described in the foregoing may be extended based on an international organization for standardization (ISO) based media file format, ISO/international electrotechnical commission (IEC) 14496-12 (moving picture experts group (MPEQ-4 Part 12)), developed by ISO/IEC MPEG. A multimedia content file manufactured based on various file format standards may be manufactured, distributed, and circulated widely through a wired and wireless Internet protocol (IP) network by a progressive streaming service.

An Interact television (TV), an IPTV service, and the like providing a broadcast service through an IP network by a convergence of a broadcast and communication have expanded.

Instead of a conventional file format such as mov, mp4, wmv, flv, 3gp, and the like, a progressive streaming using broadcast content manufactured in an MPEG TS standard may be provided.

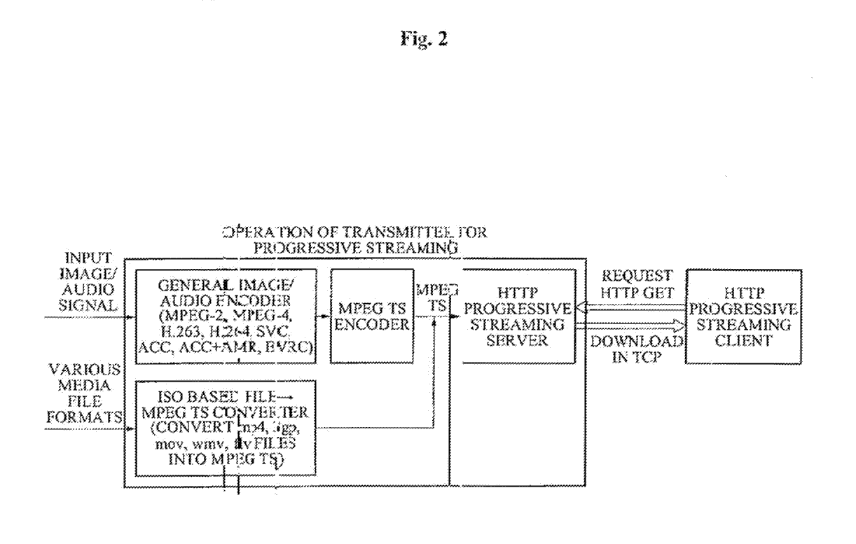

FIG. 2 is a diagram illustrating an overview of a progressive streaming service invention.

FIG. 2 illustrates an overview of a service that provides, by an HTTP progressive streaming, multimedia content manufactured by an MPEG TS standard.

An HTTP progressive streaming server may manufacture (that is, encode), in an MPEG TS standard, video/audio compression data compressed by various multimedia encoders to be used as MPEG TS broadcast content. The manufactured MPEG TS content may be serviced through the HTTP progressive streaming.

The HTTP progressive streaming server may use, for the HTTP progressive streaming service, MPEG TS content obtained by converting, into an MPEG TS, a content file manufactured in a conventional file format standard.

A client using the HTTP progressive streaming may request a server for MPEG TS content through an HTTP GET request.

In embodiments of the present invention described in the following, a method and apparatus for effectively estimating a network jitter by utilizing program clock reference (PCR) clock information included in a header of an MPEG TS packet when MPEG TS content is transmitted to a client through an IP network (for example, the wired and wireless Internet) by a progressive streaming service, will be disclosed. As used herein, network jitter may correspond to a delay variation in arrival time between arrived TCP packets.

According to embodiments of the present invention, an inter-arrival jitter corresponding to a delay variation in arrival time between packets may be estimated based on the network jitter.

Based on the estimated inter-arrival jitter of a packet, a suitable size of a de-jitter buffering used for absorbing the network jitter may be determined in designing a transport stream system target decoder (T-STD) buffer model at a reception side.

The de-jitter buffering of a terminal may absorb a difference in an arrival time between a first packet and the following packets by preventing a reception side from immediately starting a playout operation in response to the first packet arriving at the reception side. Thus, the de-jitter buffering may allow the reception side to start a playout after storing a predetermined amount of packets in a buffer so that original time intervals between the packets may be maintained.

Thus, a length of the de-jitter buffering may determine a period of time during which the first packet waits in a file buffer after the first packet arrives at the reception side and before the reception side performs, fully, an operation of playing out a video and audio.

When a de-jitter buffering time is set to be significantly short, an insufficient time for absorbing network jitters may be provided. Thus, after a playout at the reception side, a buffer underflow issue may occur within a relatively short period of time, which may cause frequent rebuffering at the reception side during a streaming between a sender and a receiver. The frequent rebuffering may significantly degrade a service quality by interrupting a playout.

In contrast, when the de-jitter buffering time is set to be significantly long, an initial playout operation starting immediately after the de-jitter buttering may be delayed in proportion to a size of a buffering. Thus, a latency for a service experienced by a user may increase.

According to embodiments of the present invention, a method and apparatus for determining an initial playout delay corresponding to a size of the de-jitter buffering and a size of a de-jitter buffering time used for absorbing an inter-arrival jitter through an estimation of an inter-packet spacing of a TCP packet in a progressive streaming service based on an MPEG TS is disclosed.

The initial playout delay may correspond to a period of time during which a first packet stays, for a de-jitter buffering, in a file buffer of a TCP before a packet is delivered to a T-STD buffer model after the first packet arrives at the reception side. Thus, the initial playout delay may determine an initial playout point in time for a received media (or content).

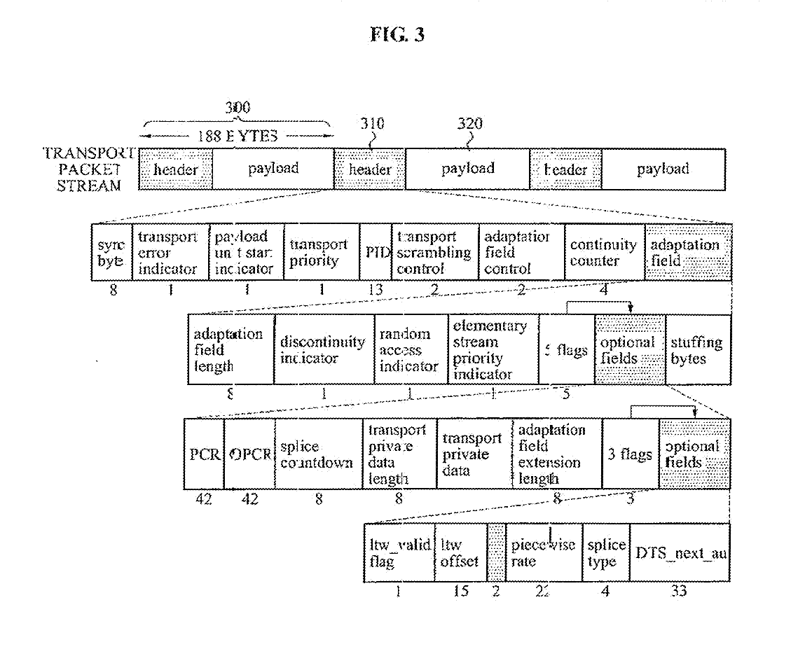

FIG. 3 is a diagram illustrating a configuration of an MPEG TS packet according to embodiments of the present invention.

An MPEG TS packet 300 may correspond to a packet having a fixed length of 188 bytes.

An MPEG TS may correspond to a continuous stream of the MPEG TS packet MPEG TS packet 300 is illustrated. Further, fields in the header 310 are hierarchically illustrated. Numbers below the fields indicate a length (in bits) of a field.

The header 310 may basically correspond to 4 bytes in length (sync byte field or continuity counter field). A length of the header 310 may increase depending on whether an adaptation field and an optional field for delivering various types of extended information are present.

The MPEG TS may correspond to a standard for effectively multiplexing and delivering video and audio compression data transmitted in a digital broadcast service.

An elementary stream of a compressed video/audio may be a packetized elementary stream (PES). A PES packet may be finely divided into TS packets having a fixed length of 188 bytes, and the divided TS packets may be transmitted by adequately multiplexing a video and audio.

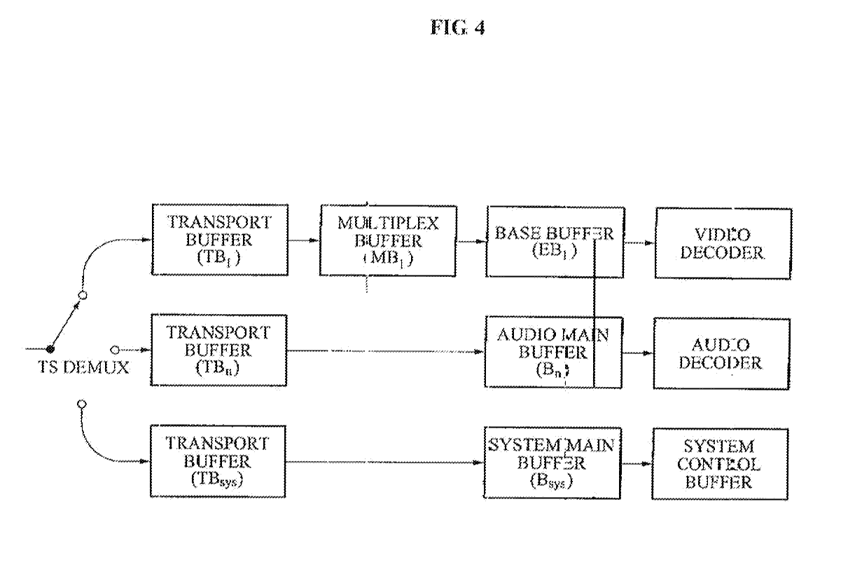

FIG. 4 is a diagram illustrating a standard transport stream system target decoder (T-STD) buffer model according to embodiments of the present invention.

An MPEG TS may generally correspond to a standard developed for a digital broadcast service. Thus, TS packets may be delivered to a receiver through a broadcasting network corresponding to a circuit switched network having a relatively stable channel quality. Thus, a packet delay time experienced by MPEG TS packets in a transmission channel may be relatively short and stable. A timing buffer model for successively processing TS packets arriving at the receiver may be effectively applied.

In an MPEG system standard (ISO/IEC 13818-1 (Part 1)), a timing buffer model at a reception side tor processing an MPEG TS may be referred to as a transport stream system target decoder (T-STD) buffer model.

FIG. 4 discloses a configuration of a standard T-STD buffer model in which TS packets related to a video, an audio, and system information that are received by being multiplexed in an MPEG TS are inverse-multiplexed, and each of inverse-multiplexed streams, in succession, is passed through a buffer.

The MPEG TS may have a standard developed to deliver multimedia data through a circuit switched network having a relatively high bandwidth quality and a relatively low transfer delay such as a broadcasting network or an asynchronous transfer mode (ATM) network.

Thus, to transmit the MPEG TS through the Internet, corresponding to a packet switched network such as an IP network, an accurate estimation of a delay variation in arrival time between packets, which is a chronic issue, may be requested. The standard T-STD buffer model of FIG. 4 designed to be suitable for a transmission of an MPEG TS through the broadcasting network may be requested to be corrected based on the estimation.

When packets are delivered through the wired and wireless Internet based on the IP network, routing paths that the packets are passed through may be different from one another, which may be different from a case in which packets are delivered through a conventional broadcasting network. Further, since an amount of traffic to be processed and a processing time may be different between routers that packets are passed through, periods of time for each of the packets to arrive at a destination may be different from each other.

Embodiments of the present invention described in the following will disclose a method of accurately estimating a delay variation in arrival time between TCP packets that occurs when the MPEG TS is delivered to a client through a progressive streaming service in a wired and wireless Internet environment. Further, embodiments of the present invention described in the following will disclose a T-STD model corrected based on an estimated delay variation in arrival time.

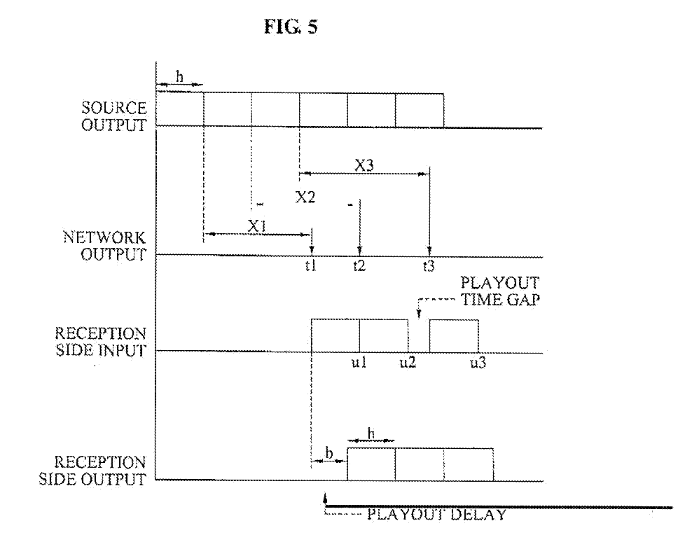

FIG. 5 is a diagram illustrating a delay variation in arrival time of a packet in an IP network according to embodiments of the present invention.

FIG. 5 illustrates an example of a dynamic variation in an arrival delay time experienced by packets when the packets are delivered through a general IP network.

Referring to FIG. 5, packets having h bytes in length may be transmitted through an IP network.

The packets may experience transmission delays x1, x2, and x3, and arrive at reception sides at points in time t1, t2, and t3, respectively while passing through the IP network.

While the transmission delay x1 equals the transmission delay x2, the transmission delay x3 may be greater than the transmission delays x1 and x2. Thus, a delay variation in arrival time may occur by b seconds between the point in time t2 and the point in time t3. A decoder based on a T-STD buffer model may smoothly operate without experiencing a buffer overflow and a buffer underflow when a playout gap such as the delay variation is eliminated.

Thus, to absorb a time gap before arriving packets are delivered to a decoder, a playout delay through a separate buffering operation such as a de-jitter buffering may be used.

To determine a size suitable for the separate buffering operation, a method of accurately estimating a delay variation in arrival time between packets may be used.

When a size of the de-jitter buffering is significantly small, a risk of the buffer underflow may be increased to generate a frequent re-buffering. When a size of the de-jitter buffering is significantly great, buffering time for arriving data may increase to generate a service latency, which degrades a service quality.

To resolve an issue described in the foregoing embodiments of the present invention described in the following will disclose a method and apparatus for effectively estimating an inter-arrival jitter by utilizing a PCR value at a reception side. he inter-arrival jitter may correspond to a delay variation in arrival time between packets.

A PCR may be included in a header of an MPEG TS packet loaded in a TCP packet. A method and apparatus for estimating an inter-arrival jitter by utilizing PCR information recorded in a TS packet may have a relatively low computational complexity and implementation complexity.

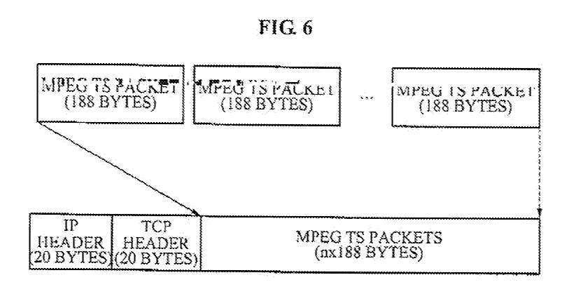

FIG. 6 is a diagram illustrating a TCP payload format including n MPEG TS packets according to embodiments of the present invention.

An MPEG TS packet may have a fixed length of 188 bytes. Thus, several TS packets may be loaded in a payload of a single TCP packet. In view of a maximum transfer unit (MTU) of the Ethernet corresponding to 1500 bytes, a maximum of seven TS packets may be theoretically loaded in a payload of a TCP.

FIG. 6 illustrates a TCP payload format that maps n TS packets to a payload of a single TCP packet.

To deliver time information that is used for synchronization between system time clocks (STCs) used at a transmission end and a reception end, a PCR may be included in a header of a TS packet.

A value of the PCR may correspond to a value obtained by sampling a point in time in a system encoder at a system clock frequency (SCF) of 27 megahertz (MHz).

A PCR clock may include a total of 42 bits. The PCR clock may include PCR_base of 33 bits in length expressed in a 90 kilohertz (kHz) (that is, SCF/300) unit, and PCR_ext of 9 bits in length expressed by a 27 MHz (that is, SCF) unit.

To continuously maintain STC synchronization between a transmission end and a reception end, the PCR may be periodically transmitted, generally within 100 milliseconds (ms).

Thus, a TS packet, among TS packets included in a payload format of a TCP packet, having PCR information in a header may be present.

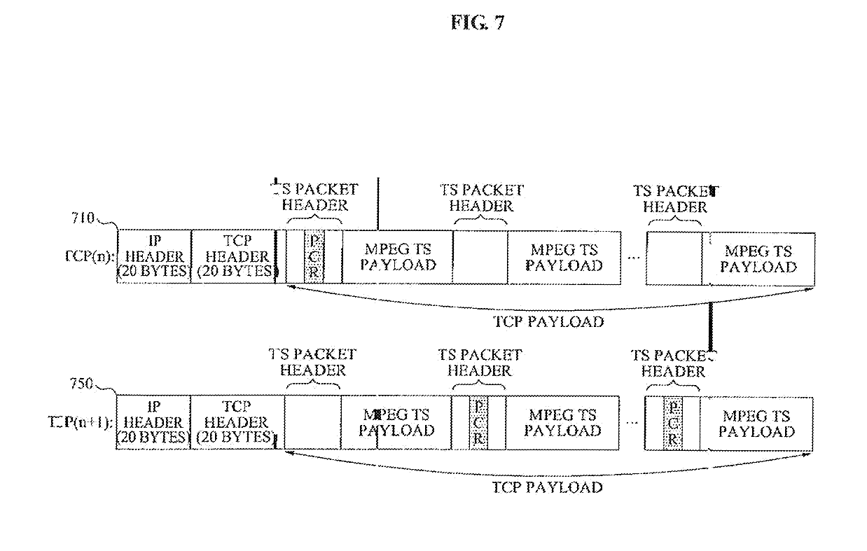

FIG. 7 is a diagram illustrating a configuration of a TCP packet that includes, in a TCP payload, TS packets including PCR information in a header according to embodiments of the present invention.

FIG. 7 illustrates payload formats of a TCP(n) 710 and a TCP(n+1) 750, respectively.

The TCP(n) 710 may correspond to an n^{th} TCP packet having, in a TCP payload, TS packets that include PCR information in a header.

The TCP(n+1) 750 may correspond to an n+1^{th} TCP packet having, in a TCP payload, TS packets that include PCR information in a header.

That is, the TCP(n) 710 and the TCP(n+1) 750 may correspond to two TCP packets having, in a TCP payload, at least one TS packet that includes PCR information in a header, and transmitted in succession.

Embodiments of the present invention described in the following will disclose a method of using PCR information included in a TCP payload to estimate a delay variation in arrival time of a TCP packet arriving at a reception side.

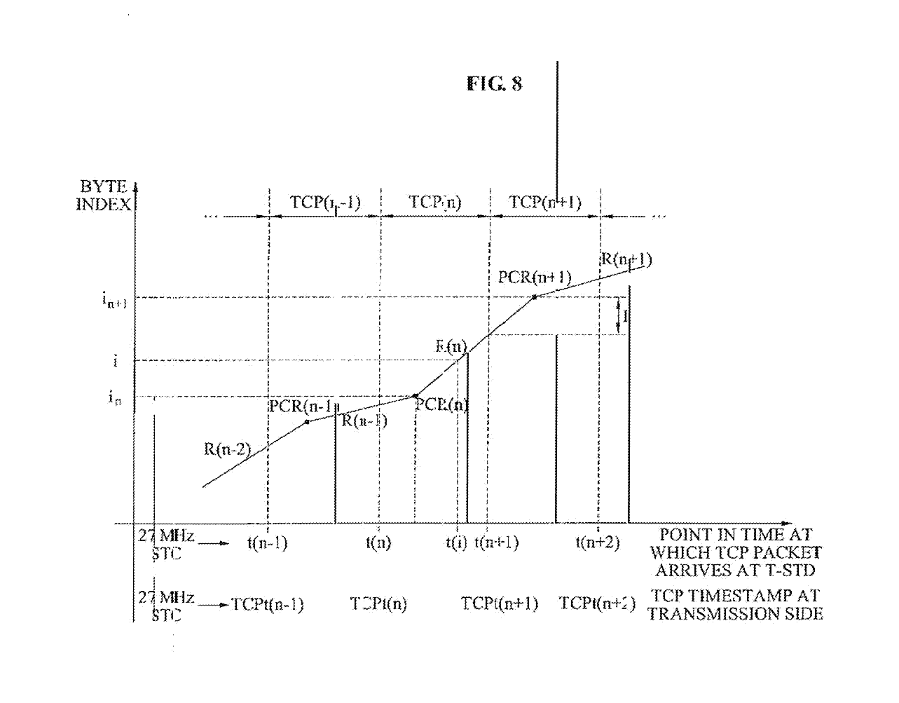

FIG. 8 is a diagram illustrating a timing model for predicting, at a transmission side, a point in time at which a TCP packet arrives at a reception side according to embodiments of the present invention.

TCP(n) denotes an TCP packet which may include, in a payload, a plurality of continuous TS packets in a similar format described with reference to FIG. 7. Here, a value n corresponds to an integer greater than or equal to 0.

A horizontal axis of FIG. 8 indicates a theoretical point in time at which a TCP packet arrives at a reception end, and the corresponding TCP timestamp value. A vertical axis indicates an index value for each of continuous data bytes transmitted to a reception side.

TCP(n) may use, as PCR(n) corresponding to a PCR value that represents TCP(n), a PCR value of a first TS packet including PCR information.

The value n may correspond to an index of TCP, that is, a value of n in TCP(n).

PCR(n) denotes an index of a first PCR in TCP(n).

iₙ denotes a byte index of the PCR(n), and iₙ₊₁ denotes a byte index of the PCR(n+1).

A point in time_t(i) at which an i^{th} data byte arrives at a reception side may be estimated according to Equation 1.

$$t ( i ) = \frac{PCR ( n )}{27 MHz} + \frac{i - {i}_{n}}{R ( n )} ( {i}_{n} < i < {i}_{n + 1} ) \qquad [ Equation 1 ]$$

Here, R(n) denotes a data transmission rate (that is, a transport rate of a transport stream) between a PCR(n) and a PCR(n+1). R(n) may be calculated according to Equation 2.

$$R ( n ) = \frac{( {i}_{n + 1} - {i}_{n} )}{( PCR ( n + 1 ) - PCR ( n ) ) / 27 MHz} \qquad [ Equation 2 ]$$

A point in time t(n+1) at which a first byte of a payload of TCP(n+1) arrives at a reception side may be calculated according to Equation 3.

$$t ( n + 1 ) = \frac{PCR ( n + 1 )}{27 MHz} - \frac{1}{R ( n )} \qquad [ Equation 3 ]$$

Here, I denotes in a byte unit, a size of all data transmitted prior to a byte including a last bit that indicates information of PCR(n+1) among all data included in TCP(n+1).

That is, the point in time t(n+1) may be calculated based on PCR(n+1), I, and R(n).

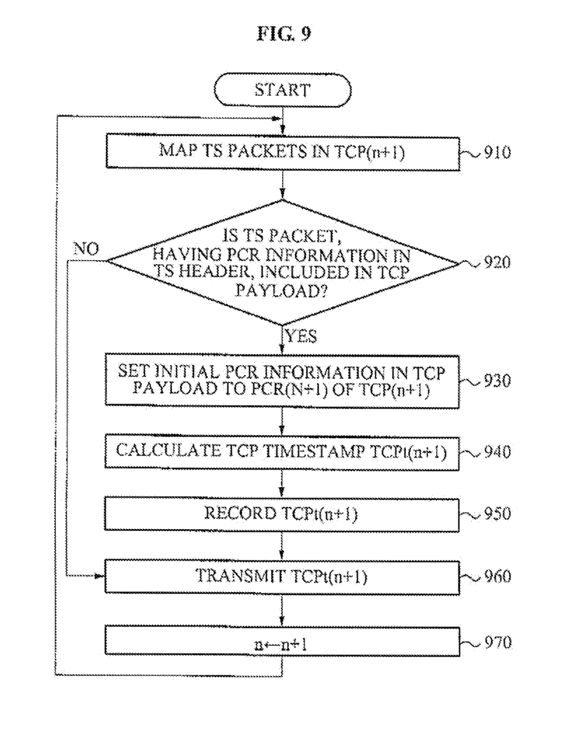

FIG. 9 is a flowchart illustrating an operational method or a transmission side according to embodiments of the present invention.

A transmission side may correspond to a streaming service transmission device, and a reception side may correspond to a streaming service reception device.

Operations 910 through 970 may indicate a method of transmitting streaming service performed by the transmission side.

In operation 910, at least one TS packet may be mapped in TCP(n+1). That is, at least one TS packets may be loaded in a payload of TCP(n+1).

In operation 920, whether a TS packet having PCR information in a TS header is included m a payload of TCP(n+1) may be verified. That is, whether a TS packet, among at least one TS packet loaded in a payload of TCP(n+1), including PCR information in a TS header is present may be verified.

When the TS packet having the PCR information in the TS header is included in the payload of TCP(n+1), operation 930 may be performed. Otherwise, operation 960 may be performed.

That is, when the PCR information fails to be recorded in headers of the at least one TS packet in the payload of TCP(n+1), a TCP timestamp described in the following may not be calculated and recorded for TCP(n+1).

In operation 930, PCR(n+1) may be set.

Initial PCR information in the at least one TS packet in the payload of TCP(n+1) may be set to PCR(n+1) of TCP(n+1).

In operation 940, a timestamp TCP(n+1) of TCP(n+1) may be calculated.

The timestamp TCPt(n+1) may correspond so a point in time at which TCP(n+1) is theoretically expected to arrive at a reception side.

A timestamp of a TCP may indicate a reference point in time tor streaming data in a TCP packet stream. The reference point in time may be calculated based on an STC in which a PCR is induced.

TCPt(n+1) may express, by a clock count value of the STC using 27 MHz SCF, a point in time corresponding to t(n+1) of FIG. 8, that is, a point in time at which a first byte of a payload of the TCP(n+1) is expected to arrive at a reception side.

Similar to PCR(n+1), TCPt(n+1) may be divided into a base clock TCPt_base(n+1) and an extension clock TCPt_ext(n+1). Thai is, TCPt(n+1) may include a base clock and an extension clock.

The base clock may use a smaller frequency unit when compared to the extension clock.

The base clock may be expressed by a 90 kHz (that, is, SCF/300) unit. The extension clock may be expressed by a 27 Mhz (that is, SCF) unit.

The timestamp TCPt(n+1), a base clock TCPt_base(n+1), and an extension clock TCPt_ext(n+1) may be calculated according to Equation 4.

TCPt_base(n+1)=((system_clock_freq×t(n+1))/300)%2³³ TCPt_ext(n+1)=((system_clock_freq×t(n+1))/1)%300 TCPt(n+1)=TCPt_base(n+1)×300+TCPt_ext(n+1) [Equation 4]

That is, the timestamp TCPt(n+1), the base clock TCPt_base(n+1), and the extension clock TCPt_ext(n+1) may be calculated based on a system clock frequency and t(n+1). TCPt(n+1) may have an accuracy of 27 MHz.

Based on Equation 4, TCPt_base(n+1) may be expressed by a total of 33 bits in length, TCPt_ext(n+1) may be expressed by a total of 9 bits in length, and TCPt(n+1) obtained by adding TCPt_base(n+1) to TCPt_ext(n+1) may be expressed, similar to the PCR, by a total of 42 bits in length.

When TCPt(n+1) reaches a maximum value, a modulo operation that resets TCPt(n+1) back to “0” may be used for calculating TCPt(n+1).

A maximum error occurring when a point in time is expressed by a clock in a 90 kHz unit may correspond to

$$\frac{1}{90 KHz} ≅ 11 µs .$$

Thus, according to a demand for an application, when an accuracy of a delay variation in arrival time is allowed to exceed 11 μs, only TCPt_base(n+1) may be used. A maximum error of 11 μs occurring when only TCPt_base(n+1) is used may be included in the delay variation in arrival time.

In a case of an application in which an error of 11 μs is not allowed in an accuracy of a delay variation in arrival time, TCPt(n+1) of 42 bits in a full length may be used.

That is, a length of bits of TCPt(n+1) may be determined based on an accuracy of a delay variation in arrival time requested by a reception side.

In operation 950, TCPt(n+1) may be recorded in TCP(n+1).

TCPt(n+1) may be stored in a header of TCP(n+1), and may be stored in an options field in the header.

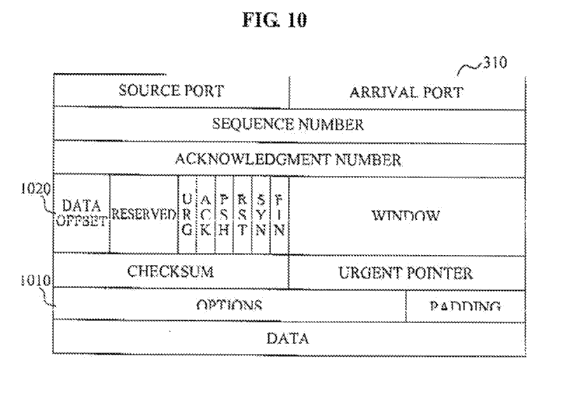

A method of storing TCPt(n+1) in the header of TCP(n+1) will be further described with reference to FIG. 10.

In operation 960, TCPt(n+1) may be transmitted to a reception side.

In operation 970, a value n may increase by “1” to process a subsequent TCP packet, and operation 910 may be performed again.

According to embodiments of the present invention, a transmission side generating and transmitting the TCP packet may correspond to a streaming server, and may correspond to an HTTP streaming server. A reception side receiving the TCP packet may correspond to a client and a terminal. The TCP packet may be received through an HTTP streaming at the reception side.

Descriptions with reference to FIG. 1 through FIG. 8 disclosed in the foregoing may be applied to the present embodiment. Thus, further descriptions will be omitted for conciseness.

FIG. 10 is a diagram illustrating a fundamental configuration of a header 310 of a TCP packet and a configuration of an extension field that may be selectively used according to embodiments of the present invention.

Basically, the header 310 of the TCP packet may have 20 bytes in length. The TCP packet may add header information up to 32 bytes by utilizing an options field 1010 to include additional information.

Whether to add the options field 1010 and a size of the options field 1010 may be designated by a value of a data offset (which indicates a length of a header) 1020.

In the embodiments described in the foregoing with reference to FIG. 9, a calculated TCP timestamp value may be added to the options field 1010.

An options field may include three types of fields such as Kind, Length, Data, and the like.

A Kind field of 1 byte in length may indicate a usage.

A Length field of 1 byte may indicate a total length of an options field corresponding to a current Kind field.

A Data field may include actual data used for an intention of the usage indicated by the Kind field.

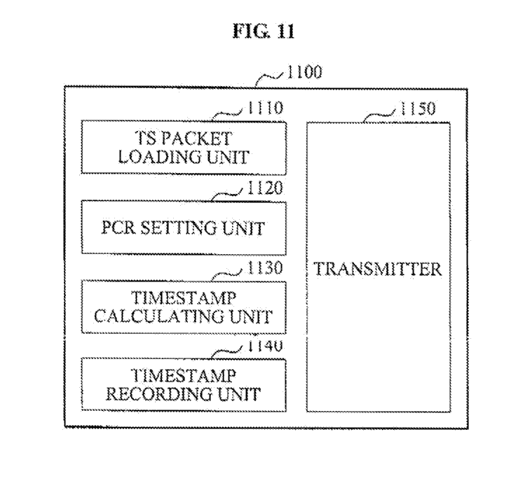

FIG. 11 is a diagram illustrating a configuration of a transmission side 1100 according to embodiments of the present invention.

The transmission side 1100 may correspond to a streaming service transmission device (for example, a streaming server)

The transmission side 1100 may include a TS packet loading unit 1100, a PCR setting unit 1120, a timestamp calculating unit 1130, a timestamp recording unit 1140, and a transmitter 1150.

The TS packet loading unit 1100 may perform operation 910, operation 920, and operation 970. For example, the TS packet loading unit 1100 may load at least one TS packet in a payload of a TCP packet.

The PCR setting unit 1120 may perform operation 930. For example, the PCR setting unit 1120 may set, to a PCR of a TCP packet, initial PCR information in at least one TC packet in a payload.

The timestamp calculating unit 1130 may perform operation 940. For example, the timestamp calculating unit 1130 may calculate a timestamp of the TCP packet based on a PCR.

The timestamp recording unit 1140 may perform operation 950. For example, the timestamp recording unit 1140 may record a timestamp calculated in the TCP packet.

The transmitter 1150 may perform operation 960. For example, the transmitter 1150 may transmit the TCP packet to a terminal.

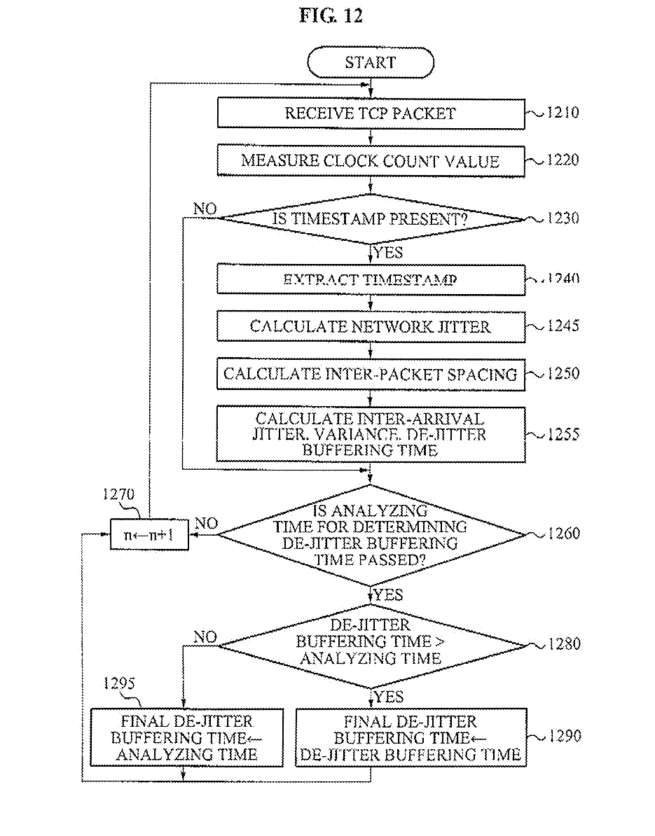

FIG. 12 is a flowchart illustrating an operational method of a reception side according to embodiments of the present invention.

Operations 1210 through 1295 may indicate a method of receiving a streaming service performed by a reception side.

The reception side may receive a TCP packet transmitted by a transmission side, described with reference to FIG 9. The reception side may use value of a TCP timestamp TCPt(n+1) transmitted by being loaded on the TCP packet.

That is, through a difference between a value of TCPt(n+1) corresponding to a theoretical point in time at which the reception side arrives and a count value of an STC clock at a moment the reception side actually arrives at a T-STD, the reception side may estimate a delay variation in arrival time experience by the TCP packet while the TCP packet is transmitted through an IP network.

In operation 1210, the TCP packet may be received. The received TCP packet may correspond to an n+1^{th} packet. An n+1^{th} TCP packet may be referred to as a first TCP packet. An n^{th} packet received before the n+1^{th} packet may be referred to as a second TCP packet. A clock count of the first TCP packet described in the following may be referred to as a first clock count.

In operation 1220, a clock count TCPt(n+1) may be measured.

TCPt(n+1) may correspond to a clock count value of an STC of the reception side at a moment the n+1^{th} TCP packet is received. The STC may be based on 27 MHz.

In operation 1230, whether a timestamp TCPt(n+1) corresponding to a TCP timestamp is present within a received TCP packet may be verified.

TCPt(n+1) denotes a point in time at which a transmission side of a TCP packet expects the reception side to receive the TCP packet.

The TCP timestamp may be present within an options field in a header of the TCP packet. Thus, whether the TCP timestamp is present within the options field in the header of the received TCP packet may be verified.

Operation 1240 may be performed when TCPt(n+1) is present within the received TCP packet, and operation 1260 may be performed, otherwise.

In operation 1240, TCPt(n+1) may be extracted from the TCP packet.

TCPt(n+1) may be extracted from the options field in the header of the TCP packet.

In operation 1245, a network jitter N(n+1) experienced by TCP(n+1). The network jitter N(n+1) may be calculated according to the following Equation 5.

$$N ( n + 1 ) = \frac{TCPt ( n + 1 ) - TCPa ( n + 1 )}{27 MHz} \qquad [ Equation 5 ]$$

When TCPt_base(n+1) having a length of 33 bytes and an accuracy of 90 kHz is recorded, as a timestamp, in a TCP packet TCP(n+1) (or, an options field of a header of a TCP packet), a network jitter N_{base}(n+1) may be calculated according to the following Equation 6.

$${N}_{base} ( n + 1 ) = \frac{TCPt\_base ( n + 1 ) - TCPa\_base ( n + 1 )}{90 KHz} \qquad [ Equation 6 ]$$

TCPa_base(n+1) denotes a base clock of TCPa(n+1), and may have a 90 kHz unit.

The network jitter N_{base}(n+1) according to Equation 6 may have an error in a range of in Equation 7 when compared to the network jitter N(n+1) according to Equation 5.

$$0 \leq N ( n + 1 ) - {N}_{base} ( n + 1 ) < \frac{1}{90 kHz} ( ≅ 11 µs ) \qquad [ Equation 7 ]$$

Thus, when an error of about 11 μs does not correspond to an issue in an application performed at the reception side, only a base clock having an accuracy of 90 kHz may be used for calculating a network jitter.

TCP(n) may correspond to a packet that arrives before TCP(n+1) arrives. That is, TCP(n) and TCP(n+1) may correspond to packets adjacent to each other. TCPt(n) may correspond to a timestamp of TCP(n). TCPa(n) may correspond to a clock count value of an STC at a reception side at a moment TCP(n) arrives. N(n) may correspond to a network jitter experienced by TCP(n).

In operation 1250, an inter-packet spacing D(n+1) between TCP(n) and TCP(n+1) may be calculated.

When TCPt(n+1) and TCPt(n) corresponding to TCP timestamps having an accuracy of 27 MHz and a length of 42 bits are used, the inter-packet spacing D(n+1) between TCP(n) and TCP(n+1) may be calculated according to Equation 8.

$$\begin{matrix}D ( n + 1 ) = \frac{1}{27 MHz} \{ \begin{matrix}( TCPt ( n + 1 ) - TCPt ( n ) ) - \\ ( TCPa ( n + 1 ) - TCPa ( n ) )\end{matrix} \} \\ = \frac{1}{27 MHz} ( TCPt ( n + 1 ) - TCPa ( n + 1 ) ) - \\ \frac{1}{27 MHz} ( TCPt ( n ) - TCPa ( n ) ) \\ = N ( n + 1 ) - N ( n )\end{matrix} \qquad [ Equation 8 ]$$

When TCPt_base(n+1) TCPt_base(n) corresponding to TCP timestamps having an accuracy of 90 MHz and a length of 33 bits are used, an inter-packet spacing D_{base}(n+1) between TCP(n) and TCP(n+1) may be calculated according to Equation 9.

$$\begin{matrix}{D}_{base} ( n + 1 ) = \frac{1}{90 KHz} \{ \begin{matrix}( \begin{matrix}TCPt\_base ( n + 1 ) - \\ TCPt\_base ( n )\end{matrix} ) - \\ ( \begin{matrix}TCPa\_base ( n + 1 ) - \\ TCPa\_base ( n )\end{matrix} )\end{matrix} \} \\ = \frac{1}{90 KHz} ( \begin{matrix}TCPt\_base ( n + 1 ) - \\ TCPa\_base ( n + 1 )\end{matrix} ) - \\ \frac{1}{90 KHz} ( \begin{matrix}TCPt\_base ( n ) - \\ TCPa\_base ( n )\end{matrix} ) \\ = {N}_{base} ( n + 1 ) - {N}_{base} ( n )\end{matrix} \qquad [ Equation 9 ]$$

An inter-packet spacing between TCP(n) and TCP(n+1) obtained based on Equation 8 and Equation 9 may be denoted by D(n+1).

In operation 1255, an inter-arrival jitter, a variance of the inter-arrival jitter, and a de-jitter buffering time may be calculated.

The inter-arrival jitter may correspond to a delay variation. In arrival time between continuously arriving packets.

An inter-arrival jitter J(n+1) of TCP(n+1) may be calculated, by a moving average, according to Equation 10.

J(n+1)=(1−α)·J(n)+α·|D(n+1)| [Equation 10]

Here, J(n) denotes an inter-arrival jitter of TCP(n).

α(0≦α≦1) denotes a first smoothing factor. A value α may adjust a reflection rate of a newly updated network jitter.

ν(n+1) denotes a variance of J(n+1). That is, ν(n+1) denotes a an inter-arrival variance of J(n+1). ν(n) denotes a variance of J(n).

ν(n+1) may be calculated, by a moving average, according to Equation 11.

ν(n+1)=(1−β)·ν(n)+β(∥D(n+1)|−J(n)|) [Equation 11]

Here, β(0≦β≦1) denotes a second smoothing factor. A value β may adjust a reaction rate tor a variance between a newly updated network jitter and an existing average jitter.

B((n+1) denotes a de-jitter buffering time for effectively absorbing J(n+1).

Based on Equation 10 and Equation 11, B(n+1) may be calculated according to the following Equation 12.

B(n+1)=J(n+1)+K·ν(n+1) [Equation 12]

Here, K denotes a parameter for reflecting a variation switch or a variance ν(n+1) that corresponds to a variable deviating from an average value of an inter-arrival jitter in determining a de-jitter buffering time.

Through operation 1255, B(n+1) may be calculated based on N(n+1) and D(n+1).

Through operations 1240 to 1255, B(n+1) may be calculated based on TCPt(n+1), TCPt(n), TCPa(n+1), and TCPa(n).

As a value K increases, a possibility that a relatively wide variation width occurring in an uncommon circumstance in a network is absorbed by a de-jitter buffering may increase.

Based on B(n+1), an initial playout delay time experienced through a de-jitter buffering, by a packet, among packets for a predetermined file (or content), that initially arrives at the reception side may be determined. Based on the determined initial playout delay time, an initial playout point in time for a progressive streaming service based on an absorption of a network jitter occurring during a transmission of a packet through an IP network may be determined.

In operation 1260, whether an analyzing time for determining a de-jitter buffering, time passed may be verified.

To estimate an adequate de-jitter buffering time by utilizing a timestamp of a received TCP packet (that is, TCP(n+1)), TCP packets may be received and analyzed during a predetermined amount of a sufficient period of time. A period of time used for receiving and analyzing may be referred to as an analyzing time T.

A sufficient period of time to reach a stable packet transmission and reception state after a TCP packet is started be transmitted may correspond to a sufficient period of time for an analysing time. Thus, about 3 to 4 hours may be sufficient for the analyzing time.

Operation 1280 may be performed when the analyzing time T for determining a de-jitter buffering time passes otherwise, operation 1270 may be performed.

In operation 1270, a value n may increase by “1” to process a subsequent packet, and operation 1210 may be performed.

In operation 1280, whether a calculated de-jitter buffering time B(n+1) exceeds the analyzing time T may be verified. Operation 1290 may be performed when the calculated de-jitter buffering time B(n+1) exceeds the analyzing time T, otherwise operation 1295 may be performed.

In operation 1290, the calculated de-jitter buffering time B(n+1) may be determined to be a final de-jitter buttering t_{dj}.

In operation 1295, the analysing time T may be determined to be the final de-jitter buffering time t_{dj}.

That is, in operations 1280, 1290, and 1295, a greater value between B(n+1) and T may be determined to be the final de-jitter buffering time t_{dj} as shown in Equation 13.

$${t}_{dj} = \{ \begin{matrix}T , & if B ( n + 1 ) < T \\ B ( n + 1 ) , & otherwise .\end{matrix} \qquad [ Equation 13 ]$$

After operation 1290 or operation 1295 is performed, operation 1270 may be performed.

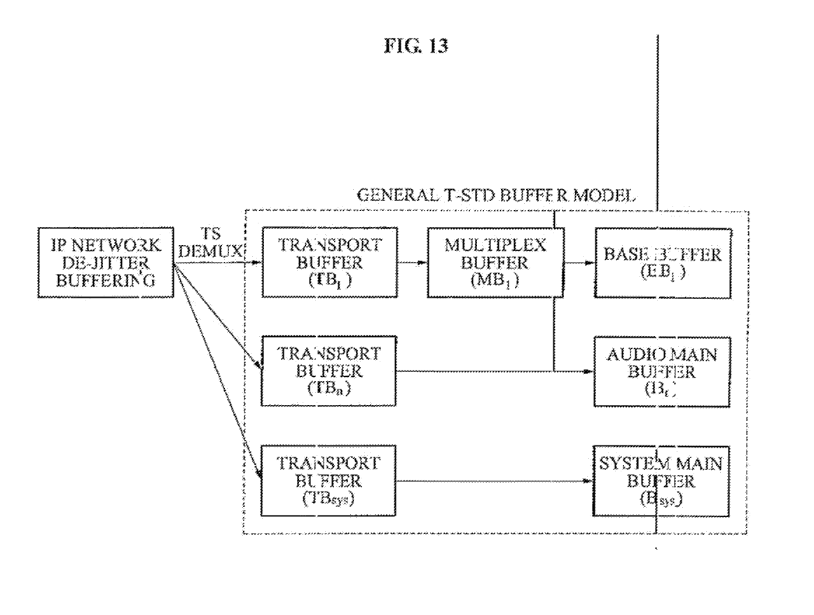

FIG. 13 is a diagram illustrating a T-STD buffer mode! including a de-jitter buffering according to embodiments of the present invention.

A T-STD buffer model may provide a de-jitter buffering for absorbing a jitter occurring when a progressive streaming service through an IP network is provided based on an inter-arrival jitter according to embodiments of the present invention described in the foregoing.

That is, the de-jitter buffering time (that is, B(n+1) or t_{dj}) calculated with reference to FIG. 12 may be set to a buffering time of a T-STD at a reception side.

An IP network de-jitter buffering for absorbing a network jitter may be performed within a file buffer of the reception side.

After the de-jitter buffering is performed, TS packets delivered to a conventional T-STD buffer mode! may be performed according to an operational principle of the conventional T-STD buffer model.

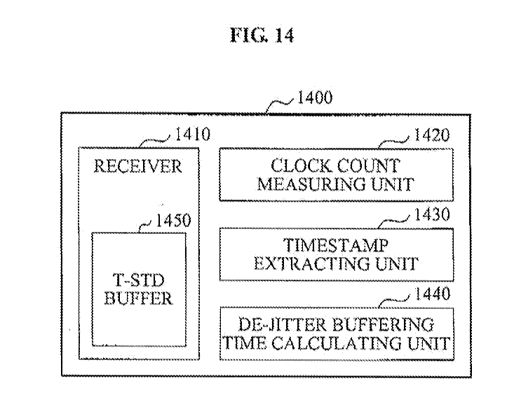

FIG. 14 is a diagram illustrating a configuration of a reception side 1400 according to embodiments of the present invention.

The reception side 1400 may correspond to a streaming service reception device (for example, a terminal).

The reception side 1400 may include a receiver 1410, a clock count measuring unit 1420, a timestamp extracting unit 1430, and a de-jitter buffering time calculating unit 1440.

The receiver 1410 may include a T-STD buffer 1450.

The receiver 1410 may perform operation 1210. For example, the receiver 1410 may receive TCP(n+1) and TCP(n).

The clock count measuring unit 1420 may perform operation 1220. For example, the clock count measuring unit 1420 may measure a clock count TCPa(n+1) at a moment TCP(n+1) is received, and measure a clock count TCPa(n) at a moment TCP(n) is received.

The timestamp extracting unit 1430 may perform operations 1230 and 1240. For example, the timestamp extracting unit 1430 may verify whether TCPt(n+1) is included in TCP(n+1), and extract TCPt(n+1) from TCP(n+1).

The de-jitter buffering time calculating unit 1440 may perform operations 1244 through 1260, 1280, 1290, and 1295. For example, the de-jitter buffering time calculating unit 1440 may calculate a dc-jitter buffering time B(n+1) or t_{dj} based on TCPt(n+1), TCPt(n), TCPa(n+1), and TCPa(n).

The de-jitter buffering time calculating unit 1440 may calculate N(n+1), N(n), N_{base}(n+1), J(n+1), J(n), D(n+1), ν(n+1), ν(n), and the like.

Descriptions with reference to FIG. 1 through FIG. 13 disclosed in the foregoing may be applied to the present embodiment. Thus, further descriptions will be omitted for conciseness.

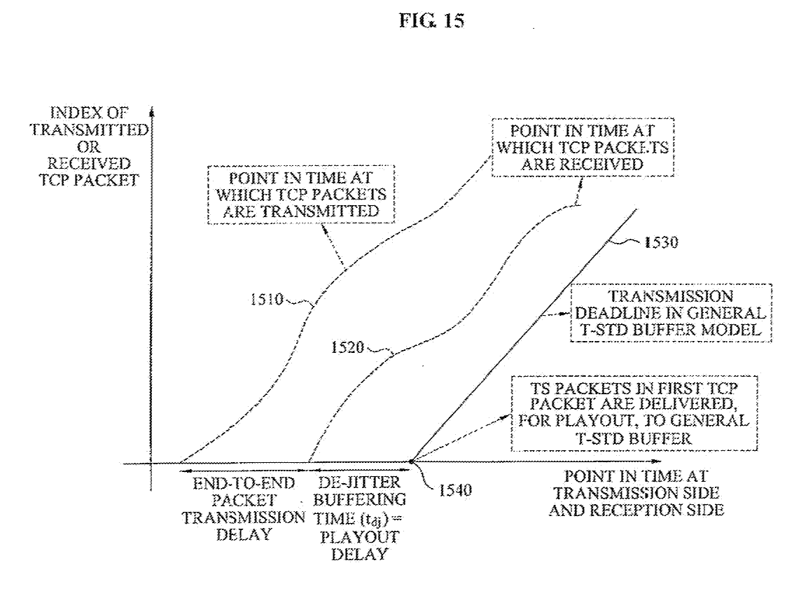

FIG. 15 is a diagram illustrating a delay of a media playout time by a de-jitter buffering according to embodiments of the present invention.

A modeling with respect to time illustrated in FIG. 15 is as the following 1) through 3).

1) A first TCP packet arriving at a file buffer may stay in a file buffer during a de-jitter buffering lime determined by embodiments of the present invention described in the foregoing.

2) Since the first TCP packet may stay in the file buffer, a playout time of content indicated by TCP packets may be delayed.

3) TS packets included in a first packet may be delivered to a conventional T-STD buffer model immediately after a set de-jitter buffering time.

Referring to FIG. 15, an x-axis indicates a point in time at a transmission side and a reception side, and a y-axis indicates an index of a transmitted or received TCP packet.

FIG. 15 illustrates a point in time 1510 at which the transmission side transmits TCP packets, a point in time 1520 at which the reception side receives the TCP packets, and a transmission deadline 1530 in a general T-STD buffer model. Further, FIG. 15 illustrates a point in time 1540 at which TS packets in first TCP packet are delivered, for playout, to a general T-STD buffer.

An end-to-end transmission delay may correspond to a difference between the point in time 1510 at which the TCP packets are transmitted and the point in time 1520 at which the TCP packets are received, and a de-jitter buffering time (that is, a playout delay time) may correspond to a difference between the point in time 1520 at which the TCP packets are received and the transmission deadline 1530 in the general T-STD buffer model.

A de-jitter buffering time according to embodiments of the present invention described in the foregoing may be considered integrated with a T-STD buffer model at a reception side to provide a high quality progressive streaming service.

Accordingly, a new T-STD barter model including a de-jitter buffering operation may follow an operational principle of the conventional T-STD buffer model except a newly added de-jitter buffering operation and thus, a T-STD buffer model developed as a conventional standard may be used without correction tor a method and apparatus according to embodiments of the present invention.

The exemplary embodiments according to the present invention may be recorded in computer-readable media including program instructions to implement various operations embodied by a computer. The media may also include, alone or in combination with the program instructions, data files, data structures, and the like. The media and program instructions may he those specially designed and constructed for the purposes of the present invention, or they may be of the well-known variety and available to those having skill in the computer software arts. Examples of computer-readable media include magnetic media such as hard disks, floppy disks, and magnetic tape; optical media such as CD ROM discs and DVD; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents,

It is to be understood that both the foregoing general description and the following detailed description are exemplary and explanatory and are intended to provide further explanation of the invention as claimed.

1. A method of transmitting a streaming service, the method comprising:
loading at least one transport stream (TS) packet in a payload of a transmission control protocol (TCP) packet;
setting, to a program clock reference (PCR) of the TCP packet, initial PCR information in the at least one TS packet in the payload;
calculating a timestamp of the TCP packet based on the PCR;
recording the timestamp in the TCP packet; and
transmitting the TCP packet to a terminal,
wherein the timestamp corresponds to a point in time at which the TCP packet is expected to arrive at the terminal.

2. The method of claim 1, further comprising:
verifying whether a TS packet, among the at least one TS packet loaded in the payload, having the PCR information is included in a TS header.

3. The method of claim 1, wherein the timestamp expresses, by a system time clock count value using a system clock frequency, an expected point in time at which a first byte of the payload is estimated to arrive at the terminal.

4. The method of claim 3, wherein, the expected point in time is calculated based on Equation 1:
$$t ( n + 1 ) = \frac{PCR ( n + 1 )}{27 MHz} - \frac{1}{R ( n )} \qquad [ Equation 1 ]$$
wherein t (n+1) denotes the expected point in time, PCR (n+1) denotes the PCR, R(n) denotes a transmission rate between the PCR and a PCR of a previous TCP packet received before the TCP packet, and I denotes, in a byte unit, a size of all data transmitted prior to a byte including a last bit that indicates information of the PCR among all data included in the TCP packet.

5. The method of claim 4, wherein the R(n) is calculated based on Equation 2:
$$R ( n ) = \frac{( {i}_{n + 1} - {i}_{n} )}{( PCR ( n + 1 ) - PCR ( n ) ) / 27 MHz} \qquad [ Equation 2 ]$$
wherein iₙ denotes a byte index of PCR(n), and iₙ₊₁ denotes a byte index of PCR(n+1).

6. The method of claim 1, wherein the timestamp comprises a base clock and an extension clock, and the base clock uses a smaller frequency unit when compared to the extension clock.

7. The method of claim 6, wherein the timestamp is calculated based on Equation 3:
TCPt_base(n+1)=((system_clock_freq×t(n+1))/300)%2³³ TCPt_ext(n+1)=((system_clock_freq×t(n+1))/1)%300 TCPt(n+1)=TCPt_base(n+1)×300+TCPt_ext(n+1) [Equation 3]
wherein TCPt_base(n+1) denotes the base clock, TCPt_ext(n+1) denotes the extension clock, TCPt(n+1) denotes the timestamp, system_clock_freq denotes a system clock frequency, and t(n+1) denotes a point in time at which a first byte of the payload is expected to arrive at the terminal.

8. The method of claim 1, wherein a length of bite of the timestamp is determined based on an accuracy of a delay variation in arrival time requested by the terminal.

9. The method of claim 1, wherein the recording comprises storing the timestamp in an options field in a header of the TCP packet.

10. An apparatus for transmitting a streaming service, the apparatus comprising:
a transport stream (TS) packet loading unit to load at least one TS packet in a payload of a transmission control protocol (TCP) packet;
a program clock reference (PCR) setting unit to set, to a PCR of the TCP packet, initial PCR information in the at least one TS packet in the payload;
a timestamp calculating unit to calculate a timestamp of the TCP packet based on the PCR;
a timestamp recording unit to record the timestamp in the TCP packet; and
a transmitter to transmit the TCP packet to a terminal,
wherein the timestamp corresponds to a point in time at which the TCP packet is expected to arrive at the terminal.

11. A method of receiving a streaming service, the method comprising:
receiving a first transmission control protocol (TCP) packet;
measuring a first clock count of a system time clock at a moment the first TCP packet is received;
extracting, from the first TCP packet, a first timestamp of the first TCP packet;
calculating a de-jitter buffering time based on the first clock count, the first timestamp, a second clock count, and a second timestamp,
wherein the first timestamp corresponds to a point in time at which a server expects the first TCP packet to be received, the second clock count corresponds to a system time clock at a moment a second TCP packet, that is received before the TCP packet, is received, and the second timestamp corresponds to a point in time, extracted from the second TCP packet, at which the server expects the second TCP packet to be received.

12. The method of claim 11, wherein the calculating comprises:
calculating a first network jitter experienced by the first TCP packet based on the first clock count and the first timestamp;
calculating a first inter-packet spacing between the second TCP packet and the first TCP packet based on the first network jitter and a second network jitter experienced by the second TCP packet; and
calculating the de-jitter buffering time based on the first network jitter and the first inter-packet spacing.

13. The method of claim 12, wherein the calculating of the de-jitter buffering time based on the first network jitter and the first inter-packet spacing comprises:
calculating a first inter-arrival jitter of the first TCP packet based on the first inter-packet spacing and a second inter-arrival jitter of the second TCP packet, the first inter-arrival jitter corresponding to a delay variation in arrival time between packets that arrive continuously;
calculating a first inter-arrival variance of the first TCP packet based on the first inter-packet spacing, a second inter-arrival variance and a second inter-packet spacing of the second TCP packet; and
calculating the de-jitter buffering time based on the first inter-arrival jitter and the first inter-arrival variance.

14. The method of claim 13, wherein the first inter-arrival jitter is calculated based on Equation 4;
J(n+1)=(1−α)·J(n)+α·|D(n+1)| [Equation 4]
wherein J(n+1) denotes the first inter-arrival jitter, J(n) denotes the second inter-arrival jitter, D(n+1) denotes the first inter-packet spacing, and α denotes a smoothing factor greater than or equal to 0 and less than or equal to 1.

15. The method of claim 13, wherein the first inter-arrival variance is calculated based on Equation 5;
ν(n+1)=(1−β)·ν(n)+β(∥D(n+1)|−J(n)|) [Equation 5]
wherein ν(n+1) denotes the first inter-arrival variance, ν(n) denotes the second inter-arrival variance, D(n+1) denotes the first inter-packet spacing, J(n) denotes the second inter-arrival jitter, and β denotes a smoothing factor greater than or equal to 0 and less than or equal to 1.

16. The method of claim 13, wherein the de-jitter buffering time is calculated based on Equation 6;
B(n+1)=J(n+1)+K·ν(n+1) [Equation 6]
wherein B(n+1) denotes the de-jitter buffering time, J(n+1) denotes the first inter-arrival jitter, ν(n+1) denotes the first inter-arrival variance, and k denotes a parameter for reflecting a variation width of the first inter-arrival variance.

17. The method of claim 11, wherein the first timestamp is within an options field in a header of the first TCP packet.

18. The method of claim 11, further comprising:
determining, to be a final de-jitter buffering time, one of the de-jitter buffering time and an analysing time,
wherein the analyzing time corresponds to a period of time sufficient for receiving and analyzing TCP packets to be received.

19. The method of claim 11, further comprising:
setting the de-jitter buffering time to a buffering time of a transport stream system target decoder.

20. An apparatus for receiving a streaming service, the apparatus comprising:
a receiver to receive a first transmission control protocol (TCP) packet;
a clock count measuring unit to measure a first clock count of a system time clock at a moment the first TCP packet is received;
a timestamp extracting unit to extract, from the first TCP packet, a first timestamp of the first TCP packet; and
a de-jitter buffering time calculating unit to calculate a de-jitter buffering time based on the first clock count, the first timestamp, a second clock count, and a second timestamp,
wherein the first timestamp corresponds to a point in time at which a server expects the first TCP packet to be received, the second clock count corresponds to a system time clock at a moment a second TCP packet, that is received before the TCP packet, is received, and the second timestamp corresponds to a point in time, extracted from the second TCP packet, at which the server expects the second TCP packet to be received.
